(19) United States
(12) Patent Application Publication
(10) Pub. No.: US 2022/0161792 A1
(43) Pub. Date: May 26, 2022

(54) VEHICLE CONTROL APPARATUS

(71) Applicant: TOYOTA JIDOSHA KABUSHIKI KAISHA, Toyota-shi (JP)

(72) Inventor: Eiichiroh MURATA, Kanagawa-ken (JP)

(73) Assignee: TOYOTA JIDOSHA KABUSHIKI KAISHA, Toyota-shi (JP)

(21) Appl. No.: 17/490,187

(22) Filed: Sep. 30, 2021

(30) Foreign Application Priority Data
Nov. 24, 2020 (JP) 2020-194163

(51) Int. Cl. B60W 30/095; B60W 30/09; B60W 30/18; B60W 40/04; B60W 40/105; B60W 10/18; B60T 8/1755

(52) U.S. Cl. CPC B60W 30/0956; B60W 30/09; B60W 30/18159; B60W 40/04; B60T 2201/022; B60W 10/18; B60T 8/17558; B60W 2554/80; B60W 40/105

(57) ABSTRACT

A vehicle control apparatus selects an oncoming vehicle, based on the object information when the own vehicle turns right or left, sets the selected oncoming vehicle as a control target vehicle, and executes a collision avoidance control of avoiding a collision of an own vehicle with the control target vehicle when a predetermined execution condition is satisfied. The vehicle control apparatus selects at least one oncoming vehicle around the control target vehicle, sets the selected at least one oncoming vehicle as a surrounding vehicle, and changes the predetermined execution condition to a condition which becomes satisfied at a later timing when a first behavior condition that there is a predetermined behavior difference between a behavior of the control target vehicle and a behavior of the surrounding vehicle, is satisfied, compared with when the first behavior condition is not satisfied.

### BACKGROUND

### Field

The invention relates to a vehicle control apparatus configured to execute a collision avoidance control.

### Description of the Related Art

There is known a vehicle control apparatus which is configured to detect objects around a vehicle and execute a collision avoidance control for avoiding a collision of the vehicle with the objects (for example, see JP 2018-156253 A). It should be noted that the collision avoidance control is also referred to as “Pre-Crash Safety Control”.

Hereinafter, the vehicles are regulated to move, keeping to the left. An apparatus described in JP 2018-156253 A (hereinafter, this apparatus will be referred to as “conventional apparatus”) is configured to execute the collision avoidance control when the conventional apparatus determines that an own vehicle is likely to collide with an object such as an oncoming vehicle while the own vehicle is turning right.

In an example shown in FIG. 14, the own vehicle 1401 is installed with the conventional apparatus. As shown by an arrow ar1, the own vehicle 1401 is turning right at an intersection Is. The oncoming vehicle 1402 is moving straight, and then will turn right at the intersection Is as shown by an arrow ar2. The conventional apparatus calculates a predicted route tr0 along which the oncoming vehicle 1402 moves. Since the oncoming vehicle 1402 is moving straight now, the predicted route tr0 is a route that the oncoming vehicle 1402 moves straight. When a distance between the own vehicle 1401 and the predicted route tr0 is shorter than a predetermined threshold, the conventional apparatus determines that the own vehicle 1401 is likely to collide with the oncoming vehicle 1402. When the conventional apparatus determines that the own vehicle 1401 is likely to collide with the oncoming vehicle 1402, the conventional apparatus executes the collision avoidance control.

In the example shown in FIG. 14, the oncoming vehicle 1402 turns right. Thus, the own vehicle 1401 is unlikely to collide with the oncoming vehicle 1402. However, as described above, the predicted route tr0 is a route that the oncoming vehicle 1402 moves straight. Thus, the distance between the own vehicle 1401 and the predicted route tr0 may become shorter than the predetermined threshold. Thus, the conventional apparatus may unnecessarily execute the collision avoidance control. In other words, the conventional apparatus may execute the collision avoidance control when the own vehicle 1401 is unlikely to collide with the oncoming vehicle 1402.

The situations described above may occur when the oncoming vehicle starts to turn right as shown by a reference symbol 1402′. As shown in FIG. 14, before the oncoming vehicle 1402′ turns considerably, the conventional apparatus calculates the predicted route tr0′ that the oncoming vehicle 1402′ moves generally straight. In this case, the distance between the own vehicle 1401 and the predicted route tr0′ is likely to become shorter than the predetermined threshold. Thus, the conventional apparatus may unnecessarily execute the collision avoidance control.

### SUMMARY

The invention has been made for solving the problems described above. An object of the invention is to provide a vehicle control apparatus which can prevent an unnecessary execution of the collision avoidance control by determining whether the oncoming vehicle is likely to turn right or left.

A vehicle control apparatus according to the invention comprises at least one sensor and a control unit. The at least one sensor which acquires object information on objects in a surrounding area around an own vehicle, which surrounding area including a forward area ahead of the own vehicle. The control unit which is configured to (i) select an oncoming vehicle which approaches the own vehicle and is likely to collide with the own vehicle, based on the object information when the own vehicle turns right or left, (ii) set the selected oncoming vehicle as a control target vehicle, and (iii) execute a collision avoidance control of avoiding a collision of the own vehicle with the control target vehicle when a predetermined execution condition that the own vehicle is likely to collide with the control target vehicle, is satisfied.

The control unit selects at least one oncoming vehicle which approaches the own vehicle and is around the control target vehicle. Further, the control unit sets the selected at least one oncoming vehicle as a surrounding vehicle. Furthermore, the control unit changes the predetermined execution condition to a condition which becomes satisfied at a later timing when a first behavior condition that there is a predetermined behavior difference between a behavior of the control target vehicle and a behavior of the surrounding vehicle, is satisfied, compared with when the first behavior condition is not satisfied.

When the first behavior condition is satisfied, there is the predetermined behavior difference in behavior between the control target vehicle and the surrounding vehicle. Thus, the control target vehicle is likely to turn right or left. Thus, the own vehicle is unlikely to collide with the control target vehicle. In this situation, the predetermined execution condition is changed to the condition which becomes satisfied at the relatively late timing. Thereby, the predetermined execution condition is unlikely to become satisfied. Thus, the unnecessary execution of the collision avoidance control can be prevented. In other words, the execution of the collision avoidance control can be prevented when the own vehicle is unlikely to collide with the control target vehicle.

According to an aspect of the invention, the control unit may be configured to determine that there is the predetermined behavior difference when there is a predetermined motion vector difference in motion vector between the control target vehicle and the surrounding vehicle or when there is a predetermined change amount difference in change amount per unit time of the motion vector between the control target vehicle and the surrounding vehicle.

According to another aspect of the invention, the control unit may be configured to determine that the first behavior condition is satisfied when at least one of (i) a first condition which relates to a difference in moving direction between the control target vehicle and the surrounding vehicle, (ii) a second condition which relates to a difference in acceleration between the control target vehicle and the surrounding vehicle, and (iii) a third condition which relates to a difference in speed in the moving direction between the control target vehicle and the surrounding vehicle, is satisfied.

The vehicle control apparatus according to this aspect of the invention can determines whether the first behavior condition is satisfied in consideration of at least one of the difference in moving direction, the difference in acceleration, and the difference in speed between the control target vehicle and the surrounding vehicle.

According to further another aspect of the invention, the control unit may be configured to determine that the first condition is satisfied when a difference between (i) an angle defined by a reference axis and the moving direction of the control target vehicle and (ii) an angle defined by the reference axis and the moving direction of the surrounding vehicle, is greater than or equal to a predetermined angle difference threshold.

According to further another aspect of the invention, the control unit may be configured to determine that the second condition is satisfied when (i) the acceleration of the control target vehicle is smaller than zero, and (ii) the acceleration of the surrounding vehicle is greater than or equal to zero.

According to further another aspect of the invention, the control unit may be configured to determine that the third condition is satisfied when (i) the speed of the control target vehicle is lower than the speed of the surrounding vehicle, and (ii) the difference in speed between the surrounding vehicle and the control target vehicle, is greater than or equal to a predetermined speed difference threshold.

According to further another aspect of the invention, the predetermined execution condition may be a condition that time which the own vehicle will take to reach a route along which the control target vehicle predictively moves, is shorter than or equal to a time threshold. In this aspect of the invention, the control unit may be configured to set the time threshold to a smaller value when the first behavior condition is satisfied, compared with when the first behavior condition is not satisfied.

The vehicle control apparatus according to this aspect of the invention changes the time threshold of the predetermined execution condition, depending on whether the first behavior condition is satisfied. Thereby, when the first behavior condition is satisfied, the predetermined execution condition is changed to the condition which becomes satisfied at the later timing, compared with when the first behavior condition is not satisfied.

According to further another aspect of the invention, the collision avoidance control may include a braking force control of applying a braking force to wheels of the own vehicle. In this aspect of the invention, when the first behavior condition is satisfied, the control unit may be configured to calculate a braking distance which the own vehicle moves until the own vehicle stops since the collision avoidance control is started to be executed. Further, in this aspect of the invention, control unit may be configured to set the time threshold to a value which allows the own vehicle to stop at a position just before the route, based on the braking distance.

In this aspect of the invention, when the first behavior condition becomes satisfied, the timing that the predetermined execution condition becomes satisfied, can be delayed to the timing which allows the own vehicle to stop at the position just before the route. Thus, the unnecessary execution of the collision avoidance control can be prevented with ensuring a safety of the own vehicle.

According to further another aspect of the invention, when the control unit selects the oncoming vehicles around the control target vehicle as the surrounding vehicles, the control unit may be configured to determine whether a second behavior condition that a behavior difference between the surrounding vehicles is small, is satisfied. In this aspect of the invention, when the second behavior condition is satisfied, the control unit may be configured to determine whether the first behavior condition is satisfied.

The vehicle control apparatus according to this aspect of the invention determines whether the first behavior condition is satisfied when the behavior difference between the surrounding vehicles is small. The vehicle control apparatus according to this aspect of the invention can accurately determine whether the control target vehicle is turning right or left.

In one or more embodiments, the control unit may be realized by a micro-processor which is programmed to execute one or more functions described in this description. Further, in one or more embodiments, the control unit may be totally or partially realized by hardware configured by integrated circuits such as ASIC dedicated to one or more applications.

Elements of the invention are not limited to elements of embodiments and modified examples of the invention described along with the drawings. The other objects, features and accompanied advantages of the invention can be easily understood from the embodiments and the modified examples of the invention.

### BRIEF DESCRIPTION OF THE DRAWINGS

FIG. 1 is a general configuration view which shows a vehicle control apparatus according to an embodiment of the invention.

FIG. 2 is a view which describes object information acquired by surrounding sensors.

FIG. 3 is a view which shows a situation that there is an oncoming vehicle when an own vehicle turns right.

FIG. 4 is a view which describes processes of setting the oncoming vehicle as a control target vehicle.

FIG. 5 is a view which describes processes of setting the oncoming vehicle as the control target vehicle.

FIG. 6 is a view which describes processes of setting the oncoming vehicle as the control target vehicle.

FIG. 7 is a view which shows a situation that there are the oncoming vehicles when the own vehicle turns right.

FIG. 8 is a view which describes a first behavior condition.

FIG. 9 is a view which describes the first behavior condition.

FIG. 10 is a view which shows another situation that there are the oncoming vehicles when the own vehicle turns right.

FIG. 11 is a view which shows a flowchart of a collision avoidance control execution routine executed by a CPU of a collision avoidance ECU.

FIG. 12 is a view which shows a flowchart of a threshold setting routine executed at a step 1103 of the routine shown in FIG. 11 by the CPU.

FIG. 13 is a view which describes a modified example of the embodiment of the invention which sets a second time threshold of a predetermined PCS execution condition.

FIG. 14 is a view which describes a situation that there is the oncoming vehicle when the own vehicle turns right.

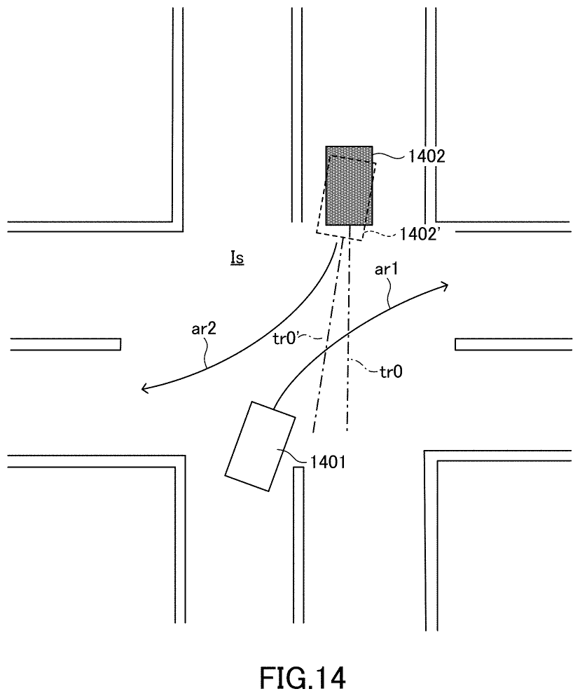

### DESCRIPTION OF THE EMBODIMENTS

<Configuration>

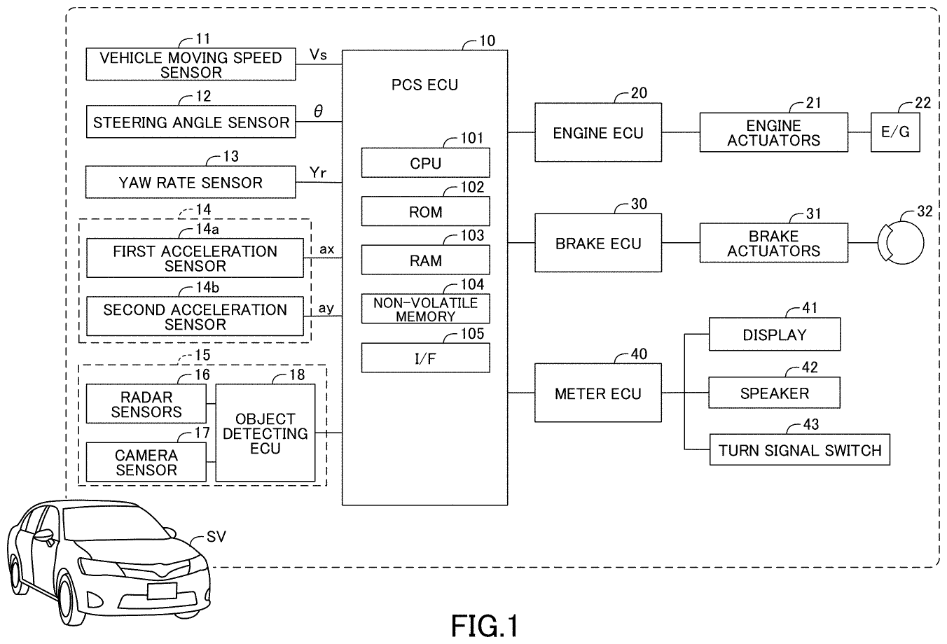

A vehicle control apparatus according to an embodiment of the invention is applied to a vehicle SV as shown in FIG. 1. The vehicle control apparatus includes a collision avoidance ECU 10, an engine ECU 20, a brake ECU 30, and a meter ECU 40. Some or all of the ECUs 10, 20, 30, and 40 may be integrated to one ECU. Hereinafter, the collision avoidance ECU 10 will be referred to as “PCS ECU 10”.

Each of the ECUs 10, 20, 30, and 40 is an electronic control unit which includes a micro-computer as a main component. The ECUs 10, 20, 30, and 40 are electrically connected to each other via a CAN (Controller Area Network) not shown. The ECUs 10, 20, 30, and 40 can send and receive information to and from each other via the CAN.

In this description, the micro-computer includes a CPU, a ROM, a RAM, a non-volatile memory, and an interface IF. For example, the PCS ECU 10 includes a micro-computer which includes a CPU 101, a ROM 102, a RAM 103, a non-volatile memory 104, and an interface (IF) 105. The CPU is configured or programmed to realize various functions by executing instructions or programs or routines stored in the ROM.

The PCS ECU 10 is electrically connected to sensors described below and is configured to receive detection signals or output signals output from the sensors. It should be noted that one or more of the sensors may be electrically connected to any of the ECUs 20, 30, and 40 other than the PCS ECU 10. When one or more of the sensors are electrically connected to any of the ECUs 20, 30, and 40 other than the PCS ECU 10, the PCS ECU 10 receives the detection signals or the output signals output from any of the ECUs 20, 30, and 40 to which the one or more sensors are electrically connected, via the CAN.

A vehicle moving speed sensor 11 detects a moving speed Vs of a vehicle SV and outputs signals which represent the moving speed Vs. A steering sensor 12 detects a steering angle ⋅ of the vehicle SV and outputs signals which represent the steering angle ⋅. A yaw rate sensor 13 detects a yaw rate Yr of the vehicle SV and outputs signals which represent the yaw rate Yr.

An acceleration sensor 14 includes a first acceleration sensor 14a and a second acceleration sensor 14b. The first acceleration sensor 14a detects a longitudinal acceleration of the vehicle SV (hereinafter, this acceleration will be referred to as “first acceleration ax”) and outputs signals which represent the first acceleration ax. The second acceleration sensor 14b detects a lateral acceleration of the vehicle SV (hereinafter, this acceleration will be referred to as “second acceleration ay”) and outputs signals which represent the second acceleration ay.

Hereinafter, information on moving states of the vehicle SV output from the sensors 11 to 14 will be also referred to as “moving state information”.

Surrounding sensors 15 are configured to acquire information on standing objects in a surrounding area around the vehicle SV. The surrounding area around the vehicle SV at least includes a front area ahead of the vehicle SV. In this embodiment, the surrounding area around the vehicle SV includes the front area ahead of the vehicle SV, a right side area at the right side of the vehicle SV, and a left side area at the left side of the vehicle SV. The standing objects are, for example, (i) moving objects such as four-wheeled vehicle, two-wheeled vehicle, and pedestrians, and (ii) non-moving objects such as electric poles, trees, and guard rails. Hereinafter, such standing objects will be also referred to as “objects”. The surrounding sensors 15 is configured to calculate information on the object (hereinafter, this information will be referred to as “object information”) and output the calculated object information.

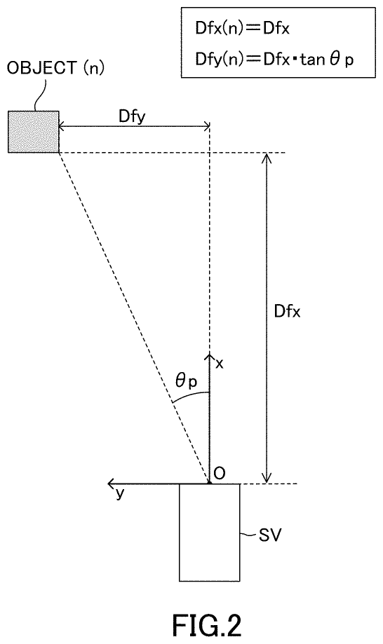

As shown in FIG. 2, the surrounding sensors 15 acquire the object information on a two dimensional map. The two dimensional map is defined by an x-axis and a y-axis. An origin of the x-axis and the y-axis is a center O of a front portion of the vehicle SV in a width direction of the vehicle SV. The x-axis extends in a longitudinal direction of the vehicle SV through the center O of the front portion of the vehicle SV. Values on the x-axis which correspond to positions forward from the vehicle SV, take positive values. The y-axis extends perpendicular to the x-axis. Values on the y-axis which correspond to positions leftward from the vehicle SV, take positive values.

The object information includes information on a longitudinal distance Dfx(n) of the object (n), a lateral position Dfy(n) of the object (n), an orientation ⋅p of the object (n) with respect to the vehicle SV, a moving direction of the object (n), a relative speed Vfx(n) of the object (n), and a type of the object (n).

The longitudinal distance Dfx(n) is a distance which has a positive or negative value in the x-axis direction between the object (n) and the origin O. The lateral position Dfy(n) corresponds to a distance which has a positive or negative value in the y-axis direction between the object (n) and the origin O. The relative moving speed Vfx(n) is a difference between a moving speed Vn of the object (n) and the moving speed Vs of the vehicle SV (=Vn−Vs). The moving speed Vn of the object (n) is a speed of the object (n) in the x-axis direction. The type of the object (n) is information on which the object is, the moving object or the non-moving object. In this embodiment, when the object is the moving object, the type of the object (n) further includes information on which the object (n) is, the four-wheeled vehicle, the two-wheeled vehicle, or the pedestrian.

Again, referring to FIG. 1, the surrounding sensors 15 include radar sensors 16, a camera sensor 17, and an object detecting ECU 18. Each radar sensor 16 includes a radar wave transmitting/receiving section and an information processing section. The radar wave transmitting/receiving section transmits electromagnetic waves and receives the electromagnetic waves reflected on the objects within a transmitting area. The electromagnetic waves are, for example, radio waves which have a millimeter wave band. The electromagnetic waves will be referred to as “millimeter waves”. Also, the electromagnetic waves reflected on the objects will be referred to as “reflected waves”. The information processing section detects the objects (n), based on reflected waver information on a phase difference between the transmitted millimeter wave and the received reflected wave, an attenuation level of the reflected wave, and time taken to receive the reflected wave since transmitting the millimeter wave. In addition, the information processing section acquires or calculates the object information on the objects (n), based on the reflected wave information.

The camera sensor 17 includes a camera and an image processing section. The camera outputs image data to the image processing section with a predetermined frame rate. The image processing section detects the objects (n), based on the image data and acquires or calculates the object information on the objects (n). It should be noted that the image processing section specifies or determines the type of the object (n). The image processing section has memorized pattern data on the objects such as the four-wheeled vehicles, the two-wheeled vehicles, and the pedestrians in the memory such as the ROM. The image processing section determines which the object is, the four-wheeled vehicle, or the two-wheeled vehicle, or the pedestrian by carrying out a pattern matching of the image data.

The image processing section may detect lane markings which define lanes, based on the image data. The lane markings include (i) the lane markings which define a moving lane in which the vehicle SV moves and (ii) the lane markings which define an oncoming lane. The image processing section may acquire or calculate positions of the lane markings as lane marking information.

The object detecting ECU 18 determines the conclusive object information by synthesizing the object information acquired by the radar sensors 16 and the object information acquired by the camera sensor 17. The object detecting ECU 18 outputs the object information and the lane information to the PCS ECU 10 as vehicle surroundings information.

The engine ECU 20 is electrically connected to engine actuators 21. The engine actuators 21 include a throttle valve actuator which changes an opening degree of a throttle valve of a spark-ignition gasoline-injection type of an internal combustion engine 22. The engine ECU 20 can change torque generated by the internal combustion engine 22 by activating the engine actuators 21. The torque generated by the internal combustion engine 22 is transmitted to driven wheels (not shown) via a transmission (not shown). Thus, the engine ECU 20 can control driving force and change an acceleration state or an acceleration by controlling the engine actuators 21.

It should be noted that when the vehicle SV is a hybrid electric vehicle (HEV), the engine ECU 20 can control the driving force generated by one or both of the internal combustion engine and at least one electric motor as vehicle driving sources. In addition, when the vehicle SV is a battery electric vehicle (BEV), the engine ECU 20 can control the driving force generated by at least one electric motor as the vehicle driving source.

The brake ECU 30 is electrically connected to brake actuators 31. The brake actuators 31 include hydraulic circuits. The hydraulic circuits include a master cylinder, fluid paths, valves, pumps, and motors which activate the pumps. The brake ECU 30 adjusts hydraulic pressure supplied to wheel cylinders installed in brake mechanisms 32 by controlling the brake actuators 31. The wheel cylinders generate friction braking force to wheels of the vehicle SV by the hydraulic pressure. Thus, the brake ECU 30 can control the braking force and change the acceleration state or a deceleration or a negative acceleration by controlling the brake actuators 31.

The meter ECU 40 is electrically connected to a display 41, a speaker 42, and a turn signal switch 43. The display 41 is a multi-information display provided in front of a driver's seat. It should be noted that the display 41 may be a head-up display. The meter ECU 40 displays an alerting mark, for example, a warning lamp on the display 41 in response to commands sent from the PCS ECU 10. Further, the meter ECU 40 outputs alerting sound for alerting the driver from the speaker 42 in response to the commands sent from the PCS ECU 10. Furthermore, the meter ECU 40 blinks left and right turn signal lamps or direction indicators or blinkers or winkers (not shown) in response to commands sent from the turn signal switch 43. The meter ECU 40 sends activated states of the left and right turn signal sumps to the PCS ECU 10.

<Summary of Collision Avoidance Control>

Hereinafter, the vehicle SV will be referred to as “own vehicle SV” in order to distinguish the vehicle SV from other vehicles. The PCS ECU 10 is configured to execute a collision avoidance control. The collision avoidance control of this embodiment is a control of avoiding a collision of the own vehicle SV with the oncoming vehicle or reducing damage derived from the collision of the own vehicle SV with the oncoming vehicle when the own vehicle SV is turning right. Hereinafter, the collision avoidance control will be referred to as “PCS control”.

In particular, the PCS ECU 10 determines whether the own vehicle SV is turning right, based on activated states of the right turn signal lamps and/or moving state information such as the steering angle ⋅ or the yaw rate Yr. When the PCS ECU 10 determines that the own vehicle SV is turning right, the PCS ECU 10 recognizes the objects in the surrounding area around the own vehicle SV, based on the object information included in the vehicle surroundings information. Then, the PCS ECU 10 picks up the oncoming vehicles from among the recognized objects. The oncoming vehicle is a vehicle which is in the forward area with respect to the own vehicle SV and is approaching the own vehicle SV. In this embodiment, the oncoming vehicles include the four-wheeled vehicles and the two-wheeled vehicles.

Next, the PCS ECU 10 determines whether there is a control target vehicle among the picked-up oncoming vehicles. The control target vehicle is the oncoming vehicle which the PCS control targets. Also, the control target vehicle is the oncoming vehicle which may collide with the own vehicle SV.

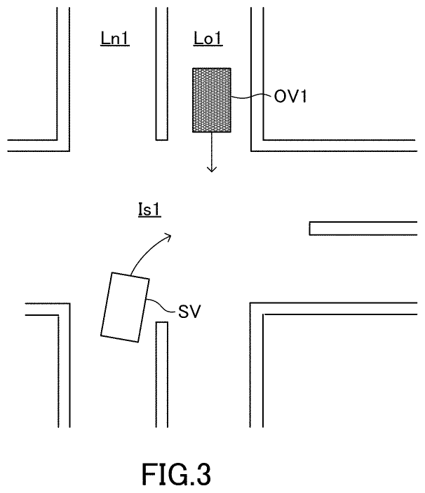

In an example shown in FIG. 3, the own vehicle SV moves in a first moving lane Lnl. The own vehicle SV is turning right at an intersection Is1. Further, a first other vehicle OV1 moves in a first oncoming lane Lo1. The first oncoming lane Lo1 is the oncoming lane for the first moving lane Lnl.

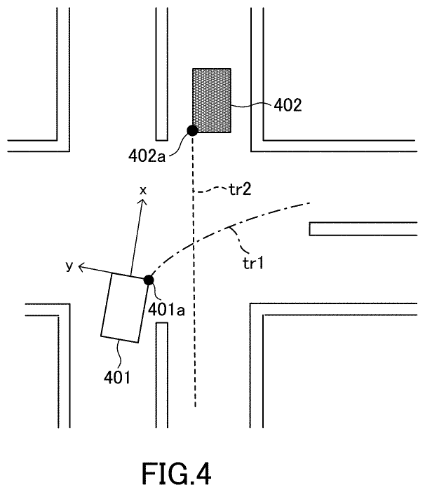

The PCS ECU 10 picks up the first other vehicle OV1 as the oncoming vehicle from among the recognized objects. Next, as shown in FIG. 4, the PCS ECU 10 virtually recognizes the own vehicle SV and the first other vehicle OV1 on the two-dimensional map. The PCS ECU 10 sets a first rectangle 401 on the two-dimensional map. The first rectangle 401 represents a body of the own vehicle SV. Information on a size of the body of the own vehicle SV has been memorized in the ROM 102. The PCS ECU 10 sets the first rectangle 401 on the two-dimensional map, based on the information on the size of the body of the own vehicle SV. In addition, the PCS ECU 10 sets a second rectangle 402 on the two-dimensional map. The second rectangle 402 represents a body of the first other vehicle OV1. It should be noted that a size of the second rectangle 402 may be set, based on a size of a body of a general vehicle.

The PCS ECU 10 determines a first apex 401a of the first rectangle 401. The first apex 401a is an apex of the first rectangle 401 nearest the second rectangle 402. The first apex 401a corresponds to a right corner portion of a front portion of the own vehicle SV. In addition, the PCS ECU 10 determines a second apex 402a of the second rectangle 402. The second apex 402a is an apex of the second rectangle 402 nearest the first rectangle 401. The second apex 402a corresponds to a right corner portion of a front portion of the first other vehicle OV1.

The PCS ECU 10 draws a first predicted route tr1 of the first apex 401a on the two-dimensional map, based on the moving state information such as the moving speed Vs and the steering angle ⋅. The first predicted route tr1 is a route along which the first apex 401a predictively moves.

The PCS ECU 10 determines a moving direction of the first other vehicle OV1, based on the object information. Then, the PCS ECU 10 draws a second predicted tr2 of the second apex 402a along the moving direction of the first other vehicle OV1 o the two-dimensional map. The second predicted route tr2 is a route along which the second apex 402a predictively moves.

The PCS ECU 10 determines whether the first other vehicle OV1 is the control target vehicle, using the first predicted route tr1 and the second predicted route tr2. In this embodiment, the PCS ECU 10 determines that the first other vehicle OV1 is the control target vehicle when a condition A1 and a condition A2 described below are both satisfied. The condition A1 and the condition A2 will be also collectively referred to as “control target vehicle condition”.

<Condition A1>

The condition A1 is a condition used to determine whether the own vehicle SV may collide with the first other vehicle OV1. The PCS ECU 10 acquires the present moving speed Vs of the own vehicle SV from the vehicle moving speed sensor 11. In addition, the PCS ECU 10 calculates a present moving speed V1 of the first other vehicle OV1, based on the object information. The PCS ECU 10 executes processes described below on the two-dimensional map, assuming that the acquired present moving speed Vs of the own vehicle SV is not changed, and the calculated present moving speed V1 of the first other vehicle OV1 is not changed.

In particular, the PCS ECU 10 moves the first rectangle 401 from a present position thereof along the first predicted route tr1 at the acquired present moving speed Vs with time. Similarly, the PCS ECU 10 moves the second rectangle 402 along the second predicted route tr2 at the calculated present moving speed V1 with time. When at least a part of the first rectangle 401 overlaps the second rectangle 402, the PCS ECU 10 determines that the own vehicle SV may collide with the first other vehicle OV1. Thus, the PCS ECU 10 determines that the condition A1 is satisfied. It should be noted that when the first rectangle 401 does not overlap the second rectangle 402, the PCS ECU 10 determines that the condition A1 is not satisfied.

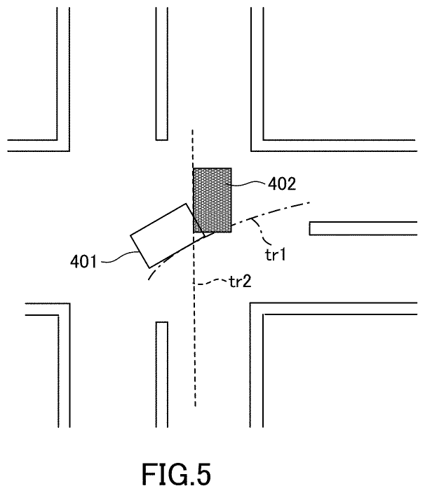

In this example, as shown in FIG. 5, at least a part of the first rectangle 401 overlaps the second rectangle 402. Thus, the PCS ECU 10 determines that the condition A1 is satisfied.

<Condition A2>

The condition A2 is a condition which is determined when the condition A1 becomes satisfied. The condition A2 is satisfied when a time Tc is relatively short. The time Tc is a time which the own vehicle SV will need to take to reach a moving route (i.e., the second predicted route tr2) of the first other vehicle OV1. It should be noted that the time Tc may be a spare time until the own vehicle SV collides with the first other vehicle OV1.

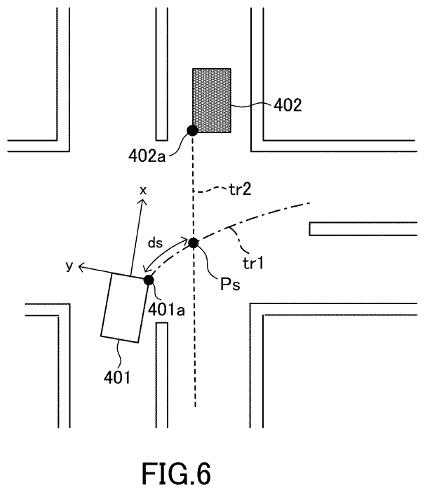

As shown in FIG. 6, the PCS ECU 10 sets the first rectangle 401 at the present position of the own vehicle SV on the two-dimensional map and sets the second rectangle 402 at a present position of the first other vehicle OV1 on the two-dimensional map. The PCS ECU 10 acquires a crossing position Ps at which the first predicted route tr1 crosses the second predicted route tr2. Then, the PCS ECU 10 acquires the time Tc by dividing a distance ds by the acquired present moving speed Vs. The distance ds is a distance between the present position of the first apex 401a and the crossing position Ps. When the time Tc is shorter than or equal to a first time threshold Tth1, the PCS ECU 10 determines that the condition A2 is satisfied. On the other hand, when the time Tc is not shorter than or equal to the first time threshold Tth1, the PCS ECU 10 determines that the condition A2 is not satisfied.

In this example, the time Tc is shorter than or equal to the first time threshold Tth1. Thus, the PCS ECU 10 determines that the condition A2 is satisfied.

As described above, in the example shown in FIG. 3, the conditions A1 and A2 as to the first other vehicle OV1 are both satisfied. Thus, the PCS ECU 10 selects or sets the first other vehicle OV1 as the control target vehicle.

After the PCS ECU 10 selects the first other vehicle OV1 as the control target vehicle, the PCS ECU 10 repeatedly calculates the time Tc as to the control target vehicle. Then, the PCS ECU 10 determines that a predetermined PCS execution condition is satisfied.

The predetermined PCS execution condition is a condition used to determine whether the PCS control should be executed or be started to be executed. The predetermined PCS execution condition is satisfied when the own vehicle SV is likely to collide with the control target vehicle. In particular, the predetermined PCS execution condition is satisfied when the time Tc is shorter than or equal to a second time threshold Tth2. The second time threshold Tth2 is a threshold used to determine a timing of starting to execute the PCS control. The second time threshold Tth2 is set to a value smaller than the first time threshold Tth1 (Tth2<Tth1).

When the time Tc becomes shorter than or equal to the second time threshold Tth2, the PCS ECU 10 determines that the predetermined PCS execution condition becomes satisfied and executes the PCS control.

The PCS control includes a driving force limiting control, a braking force control, and an alerting control. The driving force limiting control is a control of limiting the driving force applied to the own vehicle SV. The braking force control is a control of applying the braking force to the wheels of the own vehicle SV. The alerting control is a control of alerting the driver of the own vehicle SV. In particular, the PCS ECU 10 sends driving command signals to the engine ECU 20. When the engine ECU 20 receives the driving command signals from the PCS ECU 10, the engine ECU 20 controls the engine actuators 21. Thereby, the engine ECU 20 limits the driving force applied to the own vehicle SV so as to control the actual acceleration of the own vehicle SV to a target acceleration AG (for example, zero) represented by the driving command signal. In addition, the PCS ECU 10 sends braking command signals to the brake ECU 30. When the brake ECU 30 receives the braking command signals from the PCS ECU 10, the brake ECU 30 controls the brake actuators 31. Thereby, the PCS ECU 10 applies the braking force to the wheels of the own vehicle SV so as to control the actual acceleration of the own vehicle SV to a target deceleration TG represented by the braking command signal. In addition, the PCS ECU 10 sends alerting command signals to the meter ECU 40. When the meter ECU 40 receives the alerting command signals from the PCS ECU 10, the meter ECU 40 displays the alerting mark on the display 41 and outputs the alerting sounds from the speaker 42.

<Summary of Operations>

As described above, the conventional apparatus may execute the PCS control even when the own vehicle is unlikely to collide with the control target vehicle while the control target vehicle (i.e., the oncoming vehicle) turns right. Accordingly, the PCS ECU 10 determines whether the control target vehicle is likely to turn right, based on a behavior of the oncoming vehicles around the control target vehicle. When the PCS ECU 10 determines that the control target vehicle is likely to turn right, the PCS ECU 10 delays the timing of starting to execute the PCS control. In other words, the PCS ECU 10 decreases the second time threshold Tth2 used to determine the timing of starting to execute the PCS control. Thereby, the predetermined PCS execution condition becomes unlikely to be satisfied. Thus, the PCS ECU 10 can prevent an execution of the PCS control in an unnecessary situation that the own vehicle SV is unlikely to collide with the control target vehicle.

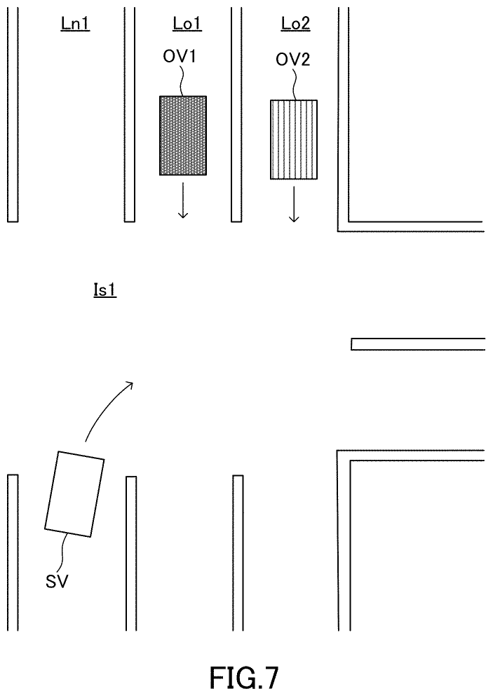

In an example shown in FIG. 7, the own vehicle SV is in the first moving lane Lnl and is turning right at the intersection Is1. In addition, the first other vehicle OV1 and a second other vehicle OV2 move in the oncoming lanes for the first moving lane Lnl. The oncoming lanes include a first oncoming lane Lo1 and a second oncoming lane Lo2. The first other vehicle OV1 moves in the first oncoming lane Lo1, and the second other vehicle OV2 moves in the second oncoming lane Lo2. In this embodiment, the first oncoming lane Lo1 is a right-turn-only lane.

The PCS ECU 10 recognizes the objects in the surrounding area around the own vehicle SV, based on the object information. The PCS ECU 10 picks up the first other vehicle OV1 and the second other vehicle OV2 as the oncoming vehicles from among the recognized objects. The PCS ECU 10 determines whether any of the first other vehicle OV1 and the second other vehicle OV2 is the control target vehicle. In particular, the PCS ECU 10 determines whether the control target vehicle condition (i.e., the conditions A1 and A2) is satisfied as to the first other vehicle OV1 and the second other vehicle OV2, respectively. In this example, the control target vehicle condition is satisfied only as to the first other vehicle OV1. Thus, the PCS ECU 10 selects the first other vehicle OV1 as the control target vehicle.

It should be noted that the control target vehicle condition may be satisfied as to both of the first other vehicle OV1 and the second other vehicle OV2. In this case, the PCS ECU 10 selects the oncoming vehicle nearer the own vehicle SV (in this example, the first other vehicle OV1) as the control target vehicle. In other words, the PCS ECU 10 selects the oncoming vehicle which predictively collides with the own vehicle SV at an earliest timing, as the control target vehicle.

In addition, the PCS ECU 10 picks up the oncoming vehicles which satisfies both of a condition B1 and a condition B2 described below, from among the oncoming vehicles other than the control target vehicle. The PCS ECU 10 selects or sets the picked-up oncoming vehicles as surrounding vehicles. The surrounding vehicle is a vehicle which moves around the control target vehicle.

Condition B1: The oncoming vehicle is within a predetermined distance range from the control target vehicle.

Condition B2: The oncoming is not behind the control target vehicle. In other words, the oncoming vehicle is not in the same lane as the lane in which the control target vehicle moves.

Hereinafter, the condition B1 and the condition B2 will be also collectively referred to as “surrounding vehicle condition”. In this example, the surrounding vehicle condition is satisfied as to the second other vehicle OV2. Thus, the PCS ECU 10 selects the second other vehicle OV2 as the surrounding vehicle.

Hereinafter, the first other vehicle OV1 will be referred to as “control target vehicle OV1”, and the second other vehicle OV2 will be referred to as “surrounding vehicle OV2”. For example, when the control target vehicle OV1 is turning right, the control target vehicle OV1 decelerates or starts to turn. On the other hand, the surrounding vehicle OV2 may move straight without decelerating. As such, when the control target vehicle OV1 is turning right, behaviors such as the moving speed, the acceleration, and the moving direction of the control target vehicle OV1 are different from behaviors of the surrounding vehicle OV2.

Accordingly, the PCS ECU 10 determines whether a predetermined first behavior condition is satisfied, based on the object information. The predetermined first behavior condition is a condition used to determine whether there is a predetermined behavior difference between the behavior of the control target vehicle OV1 and the behavior of the surrounding vehicle OV2. In this description, a behavior difference is a difference in motion vector between the control target vehicle OV1 and the surrounding vehicle OV2. The motion vector is defined by a moving direction and a moving speed. Alternatively, the behavior difference is a difference in a change amount of the motion vector per unit time between the control target vehicle OV1 and the surrounding vehicle OV2, i.e., a change amount of the moving direction per unit time and a change amount the moving speed per unit time between the control target vehicle OV1 and the surrounding vehicle OV2. In particular, the predetermined first behavior condition is satisfied when at least one of a condition C1, a condition C2, and a condition C3 described below is satisfied.

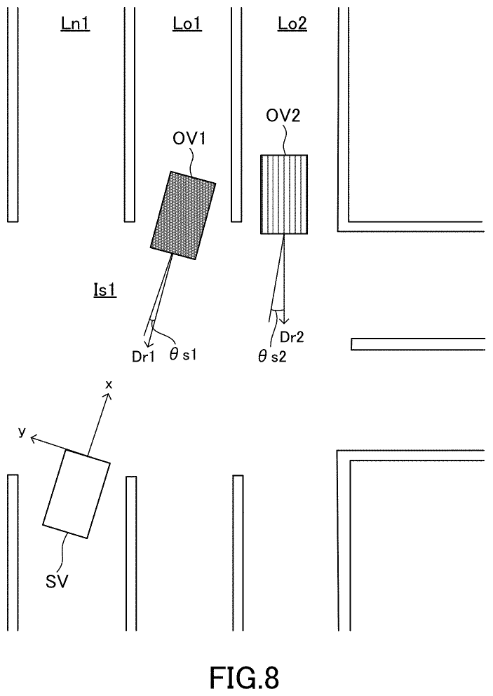

The condition C1 is a condition which relates to a particular angle defined by a predetermined reference axis and the moving direction of the vehicle. In this embodiment, the predetermined reference axis is the x-axis of the own vehicle SV. As shown in FIG. 8, the particular angle ⋅s1 of the control target vehicle OV1 is an angle defined by the x-axis and the moving direction Drl of the control target vehicle OV1, and the particular angle ⋅s2 of the surrounding vehicle OV2 is an angle defined by the x-axis and the moving direction Dr2 of the surrounding vehicle OV2.

When the control target vehicle OV1 starts to turn right, there is a difference between the particular angle ⋅s1 of the control target vehicle OV1 and the particular angle ⋅s2 of the surrounding vehicle OV2. Thus, in this embodiment, the condition C1 is a condition below.

Condition C1: A magnitude of a difference (=|⋅s1−⋅s2|) between the particular angle ⋅s1 of the control target vehicle OV1 and the particular angle ⋅s2 of the surrounding vehicle OV2 is greater than or equal to a predetermined threshold (in this embodiment, a first angle difference threshold ⋅thl).

It should be noted that the predetermined reference axis is not limited to the x-axis of the own vehicle SV. For example, the predetermined reference axis may be the moving direction of the oncoming lane, i.e., a direction in which the oncoming lane extends.

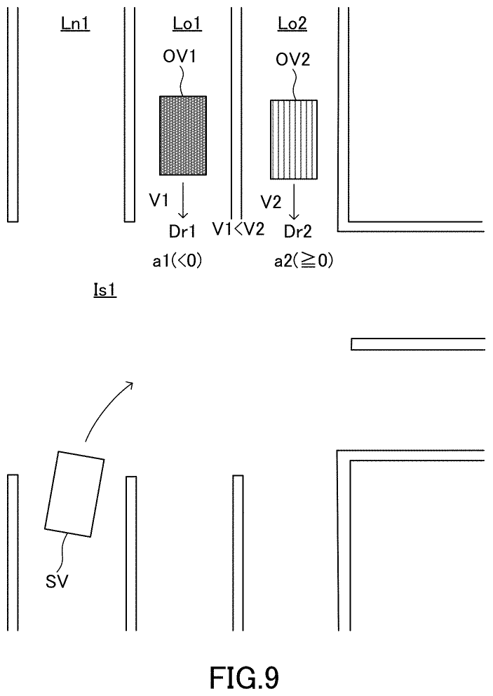

The condition C2 is a condition which relates to the acceleration of the vehicle. As shown in FIG. 9, when the control target vehicle OV1 is turning right at the intersection Is1, the control target vehicle OV1 is likely to decelerate before the control target vehicle OV1 moves into the intersection Is1. On the other hand, the surrounding vehicle OV2 is likely to move at a constant moving speed or accelerate. Thus, in this embodiment, the condition C2 is a condition described below.

Condition C2: The acceleration a1 of the control target vehicle OV1 is a negative value, and the acceleration a2 of the surrounding vehicle OV2 is greater than or equal to zero.

It should be noted that the condition C2 may be a condition described below.

Condition C2: The acceleration a1 of the control target vehicle OV1 is a negative value, the acceleration a2 of the surrounding vehicle OV2 is greater than the acceleration a1 of the control target vehicle OV1, and a magnitude of a difference (=|a1−a2|) between the acceleration a1 of the control target vehicle OV1 and the acceleration a2 of the surrounding vehicle OV2 is greater than a predetermined threshold (in this embodiment, a first acceleration difference threshold athl).

The condition C3 is a condition which relates to the moving speed of the vehicle. As shown in FIG. 9, when the control target vehicle OV1 is turning right at the intersection Is1, the control target vehicle OV1 is likely to move at the low moving speed before the control target vehicle OV1 moves into the intersection Is1. On the other hand, the surrounding vehicle OV2 is likely to move at the moving speed higher than the moving speed of the control target vehicle OV1. Thus, in this embodiment, the condition C3 is a condition described below.

Condition C3: The moving speed Vi of the control target vehicle OV1 is slower than the moving speed V2 of the surrounding vehicle OV2, and a difference (=V2−V1) between the moving speed V2 and the moving speed V1 is greater than or equal to a predetermined threshold (in this embodiment, a first speed difference threshold Vthl).

When the first behavior condition is not satisfied, i.e., any of the conditions C1 to C3 is not satisfied, the control target vehicle OV1 is unlikely to turn right. Thus, when the first behavior condition is not satisfied, the PCS ECU 10 sets the second time threshold Tth2 to a first value Ti (i.e., a normal value).

On the other hand, when the predetermined first behavior condition is satisfied, the control target vehicle OV1 is likely to turn right. Thus, when the predetermined first behavior condition is satisfied, the PCS ECU 10 sets the second time threshold Tth2 to a second value T2. The second value T2 is smaller than the first value T1.

With the configuration described above, when the predetermined first behavior condition is satisfied between the control target vehicle OV1 and the surrounding vehicle OV2, the PCS ECU 10 sets the second time threshold Tth2 to a value (T2) smaller than a value (Ti) which is set as the second time threshold Tth2 when the predetermined first behavior condition is not satisfied. Thus, when the predetermined first behavior condition is satisfied, the predetermined PCS execution condition becomes satisfied at a later timing, compared with when the predetermined first behavior condition is not satisfied. In other words, the predetermined PCS execution condition becomes unlikely to be satisfied. Thus, the PCS control becomes unlikely to be executed.

It should be noted that when the own vehicle SV is turning right, errors of turning components of the own vehicle SV may be included in the object information. In this regard, similarly, errors of turning components of the control target vehicle OV1 and the surrounding vehicle OV2 may be also included in the behaviors of the control target vehicle OV1 and the surrounding vehicle OV2, respectively. Thus, the PCS ECU 10 can determine whether the control target vehicle is likely to turn right, based on the detected behavior difference.

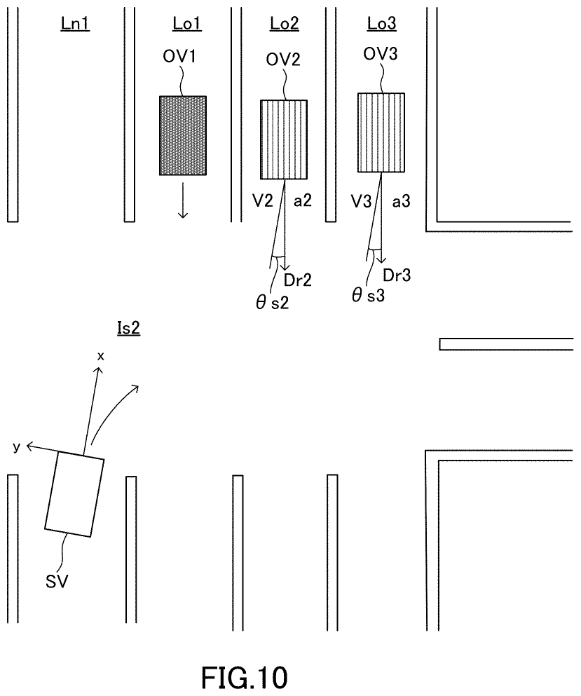

It should be noted that there may be three or more oncoming vehicles. In an example shown in FIG. 10, the own vehicle SV is in the first moving lane Lnl and is turning right at the intersection Is2. Further, the other vehicles OV1 to OV3 are in the oncoming lanes for the first moving lane Lnl. The oncoming lanes of this case include the first oncoming lane Lo1, the second oncoming lane Lo2, and a third oncoming lane Lo3. The first other vehicle OV1 moves in the first oncoming lane Lo1, the second other vehicle OV2 moves in the second oncoming lane Lo2, and the third other vehicle OV3 moves in the third oncoming lane Lo3. In this example, the first oncoming lane Lo1 is the right-turn-only lane.

In this example, the PCS ECU 10 selects the first other vehicle OV1 as the control target vehicle, and selects the second and third other vehicles OV2 and OV3 as the surrounding vehicles. Hereinafter, the first other vehicle OV1 is referred to as “control target vehicle OV1”, the second other vehicle OV2 is referred to as “first surrounding vehicle OV2”, and the third other vehicle OV3 is referred to as “second surrounding vehicle OV3”. When there are the surrounding vehicles OV2 and OV3, the PCS ECU 10 executes processes described below.

The behaviors of the surrounding vehicles OV2 and OV3 may be considerably different from each other. For example, when the surrounding vehicle OV3 turns left at the intersection Is2, the behavior such as the moving direction, the acceleration, and the moving speed of the surrounding vehicle OV3 is considerably different from the behavior of the surrounding vehicle OV2. When the PCS ECU 10 determines whether the predetermined first behavior condition is satisfied, using such behavior of the surrounding vehicle OV3, the PCS ECU 10 cannot accurately determine whether the control target vehicle OV1 is turning right.

Thus, when there are the surrounding vehicles OV2 and OV3, the PCS ECU 10 determines whether a predetermined second behavior condition is satisfied. The predetermined second behavior condition is a condition used to determine whether the difference in behavior between the surrounding vehicles OV2 and OV3 is small. In other words, the predetermined second behavior condition is a condition used to determine whether both of the surrounding vehicles OV2 and OV3 are moving straight. The predetermined second behavior condition is satisfied when conditions D1 to D3 described below are all satisfied.

Condition D1: A magnitude of a difference (=|⋅s2−⋅s3|) between the particular angle ⋅s2 of the surrounding vehicle OV2 and the particular angle ⋅s3 of the surrounding vehicle OV3 is smaller than a predetermined threshold (in this embodiment, a second angle difference threshold ⋅th2) which is near zero.

Condition D2: The acceleration a2 of the surrounding vehicle OV2 in the moving direction Dr2 thereof and the acceleration a3 of the surrounding vehicle OV3 in the moving direction Dr3 thereof are both greater than or equal to zero, and a magnitude of a difference (=|a2−a3|) between the accelerations a2 and a3 is smaller than a predetermined threshold (in this embodiment, a second acceleration difference threshold ath2).

Condition D3: a magnitude of a difference (=|V2−V3|) between the moving speed V2 of the surrounding vehicle OV2 in the moving direction Dr2 thereof and the moving speed V3 of the surrounding vehicle OV3 in the moving direction Dr3 thereof is smaller than a predetermined threshold (in this embodiment, a second speed difference threshold Vth2).

When the predetermined second behavior condition is not satisfied, the PCS ECU 10 sets the second time threshold Tth2 to the first value T1.

On the other hand, when the predetermined second behavior condition is satisfied, the PCS ECU 10 determines whether (i) the predetermined first behavior condition is satisfied between the control target vehicle OV1 and the surrounding vehicle OV2, and (ii) the predetermined first behavior condition is satisfied between the control target vehicle OV1 and the surrounding vehicle OV3. When (i) the predetermined first behavior condition is satisfied between the control target vehicle OV1 and the surrounding vehicle OV2, and (ii) the predetermined first behavior condition is satisfied between the control target vehicle OV1 and the surrounding vehicle OV3, the PCS ECU 10 sets the second time threshold Tth2 to the second value T2.

When the first behavior condition is not satisfied between the control target vehicle and any of the surrounding vehicles, the PCS ECU 10 sets the second time threshold Tth2 to the first value T1. In other words, when (i) the predetermined first behavior condition is not satisfied between the control target vehicle OV1 and the surrounding vehicle OV2, or (ii) the predetermined first behavior condition is not satisfied between the control target vehicle OV1 and the surrounding vehicle OV3, the PCS ECU 10 sets the second time threshold Tth2 to the first value T1.

As described above, when (i) there are the surrounding vehicles OV2 and OV3, and (ii) the predetermined second behavior condition is satisfied, the PCS ECU 10 determines whether the predetermined first behavior condition is satisfied. In other words, when the difference in behavior between the surrounding vehicles OV2 and OV3 is small, the PCS ECU 10 determines whether the predetermined first behavior condition is satisfied. Thereby, the PCS ECU 10 can accurately determine whether the control target vehicle OV1 is turning right.

<Operations>

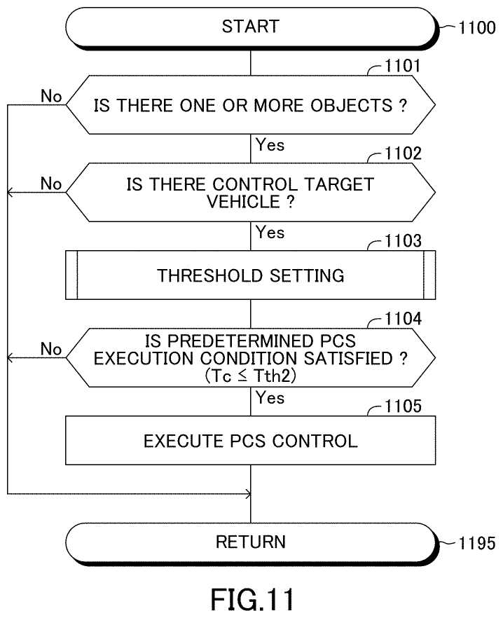

The CPU 101 of the PCS ECU 10 is configured or programmed to execute a collision avoidance control execution routine or a PCS control execution routine shown in FIG. 11. Hereinafter, the CPU 101 will be simply referred to as “CPU”. When the CPU determines that the own vehicle SV is turning right, based on (i) the activated states of the right turn signal lamps and (ii) the moving state information, the CPU executes a routine shown in FIG. 11 each time a predetermined time elapses.

It should be noted that the CPU acquires the moving state information from the sensors 11 to 14 and acquires the vehicle surroundings information from the surrounding sensors 15 each time the predetermined time elapses and stores the acquired information in the RAM 103.

At a predetermined timing, the CPU starts a process from a step 1100 of the routine shown in FIG. 11 and proceeds with the process to a step 1101 to determine whether there is one or more objects in the surrounding area around the own vehicle SV, based on the object information. When there is no object, the CPU determines “No” at the step 1101 and proceeds with the process directly to a step 1195 to terminate executing this routine once.

On the other hand, when there is one or more objects, the CPU determines “Yes” at the step 1101 and proceeds with the process to a step 1102. At the step 1102, the CPU picks up the oncoming vehicles from among the object recognized at the step 1101 and determines whether there is the control target vehicle as described above. In particular, the CPU determines whether there is the oncoming vehicle which satisfies the control target vehicle condition, among the picked-up oncoming vehicles. When there is no oncoming vehicle which satisfies the control target vehicle condition, the CPU determines “No” at the step 1102 and proceeds with the process directly to the step 1195 to terminate executing this routine once.

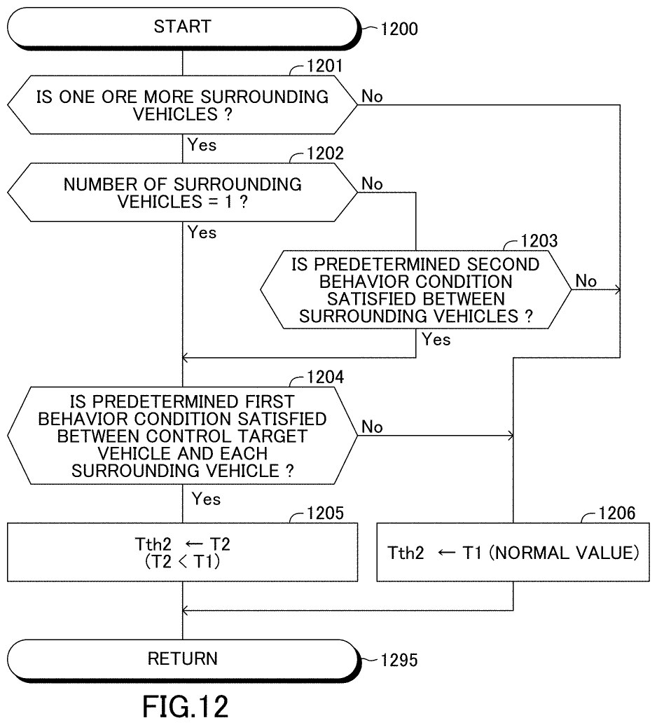

On the other hand, when there is the oncoming vehicle which satisfies the control target vehicle condition, the CPU selects the oncoming vehicle in question as the control target vehicle. Then, the CPU determines “Yes” at the step 1102 and proceeds with the process to a step 1103 to execute a threshold setting routine shown in FIG. 12 as described later. In the threshold setting routine, the CPU sets the second time threshold Tth2 to any of the first or second value T1 or T2. Then, the CPU proceeds with the process to a step 1104 to determine whether the predetermined PCS execution condition is satisfied. In particular, the CPU determines whether the time Tc is shorter than or equal to the second time threshold Tth2. When the predetermined PCS execution condition is not satisfied, the CPU determines “No” at the step 1104 and proceeds with the process directly to the step 1195 to terminate executing this routine once.

On the other hand, when the predetermined PCS execution condition is satisfied, the CPU determines “Yes” at the step 1104 and proceeds with the process to a step 1105 to execute the PCS control. Then, the CPU proceeds with the process to the step 1195 to terminate executing this routine once.

Next, the threshold setting routine which the CPU executes at the step 1103 of the routine shown in FIG. 11, will be described. When the CPU proceeds with the process to the step 1103, the CPU starts a process from a step 1200 of the routine shown in FIG. 12 and proceeds with the process to a step 1201. The CPU determines whether there is one or more surrounding vehicles. In particular, the CPU determines whether there is one or more oncoming vehicles which satisfy the surrounding vehicle condition among the oncoming vehicles other than the control target vehicle. When there is no oncoming vehicle which satisfies the surrounding vehicle condition, the CPU determines “No” at the step 1201 and proceeds with the process to a step 1206 to set the second time threshold Tth2 to the first value Ti. Then, the CPU proceeds with the process to a step 1295 to terminate executing this routine and proceeds with the process to the step 1104 of the routine shown in FIG. 11.

On the other hand, when there are the oncoming vehicles which satisfy the surrounding vehicle condition, the CPU selects the oncoming vehicles in question as the surrounding vehicles. Then, the CPU determines “Yes” at the step 1201 and proceeds with the process to a step 1202 to determine whether the number of the surrounding vehicles is “1”. When the number of the surrounding vehicles is “1”, the CPU determines “Yes” at the step 1202 and proceeds with the process to a step 1204. Then, the CPU determines whether the predetermined first behavior condition is satisfied between the control target vehicle and the surrounding vehicle. In particular, the CPU determines whether at least one of the conditions C1 to C3 is satisfied between the behavior of the control target vehicle and the behavior of the surrounding vehicle. When the predetermined first behavior condition is not satisfied, the CPU determines “No” at the step 1204 and proceeds with the process to the step 1206 to set the second time threshold Tth2 to the first value T1. Then, the CPU proceeds with the process to the step 1295 to terminate executing this routine and proceeds with the process to the step 1104 of the routine shown in FIG. 11.

On the other hand, when the predetermined first behavior condition is satisfied, the CPU determines “Yes” at the step 1204 and proceeds with the process to a step 1205 to set the second time threshold Tth2 to the second value T2. Then, the CPU proceeds with the process to the step 1295 to terminate executing this routine and proceeds with the process to the step 1104 of the routine shown in FIG. 11.

When the number of the surrounding vehicles is not “1” at the step 1202, the CPU determines “No” at the step 1202 and proceeds with the process to a step 1203 to determine whether the predetermined second behavior condition is satisfied between the surrounding vehicles. In particular, the CPU determines whether the conditions D1 to D3 are all satisfied between the surrounding vehicles. When the predetermined second behavior condition is not satisfied, the CPU determines “No” at the step 1203 and proceeds with the process to the step 1206 to set the second time threshold Tth2 to the first value T1. Then, the CPU proceeds with the process to the step 1295 to terminate executing this routine and proceeds with the process to the step 1104 of the routine shown in FIG. 11.

On the other hand, when the predetermined second behavior condition is satisfied, the CPU determines “Yes” at the step 1203 and proceeds with the process to the step 1204. When the CPU proceeds with the process to the step 1204, as described above, the CPU determines whether the predetermined first behavior condition is satisfied between the control target vehicle and each surrounding vehicle. When the predetermined first behavior condition is satisfied between the control target vehicle and each surrounding vehicle, the CPU determines “Yes” at the step 1204 and proceeds with the process to the step 1205 to set the second time threshold Tth2 to the second value T2. Then, the CPU proceeds with the process to the step 1295 to terminate executing this routine and proceeds with the process to the step 1104 of the routine shown in FIG. 11.

On the other hand, when the predetermined first behavior condition is not satisfied between the control target vehicle and each surrounding vehicle, the CPU determines “No” at the step 1204 and proceeds with the process to the step 1206 to set the second time threshold Tth2 to the first value T1. Then, the CPU proceeds with the process to the step 1295 to terminate executing this routine and proceeds with the process to the step 1104 of the routine shown in FIG. 11.

The vehicle control apparatus described above has effects described below. When the control target vehicle OV1 starts to turn right at the intersection Is1 (see FIG. 8) or when the control target vehicle OV1 moves straight just before the intersection Is1 (see FIG. 9), the predicted route of the control target vehicle OV1 (for example, see the route tr2 shown in FIG. 4) is a route which the control target vehicle OV1 moves straight. Thus, the predetermined PCS execution condition may be satisfied. With the configuration described above, in this situation, when the predetermined first behavior condition becomes satisfied, the vehicle control apparatus changes the predetermined PCS execution condition such that the predetermined PCS execution condition becomes satisfy at the later timing, compared with when the predetermined first behavior condition is not satisfied. Thereby, the PCS control is unlikely to be executed at the unnecessary situation which the own vehicle SV is unlikely to collide with the control target vehicle OV1.

It should be noted that the invention is not limited to the aforementioned embodiments, and various modifications can be employed within the scope of the invention.

### Modified Example 1

The CPU may be configured or programmed to set the second time threshold Tth2 at the step 1205 of the routine shown in FIG. 12 as described below. The CPU calculates a braking distance df with known techniques, based on the present moving speed Vs of the own vehicle SV. The braking distance df is a distance which the own vehicle SV moves until the own vehicle SV stops since the PCS control (i.e., the braking force control) is started to be executed. Then, the CPU sets the second time threshold Tth2 with an expression 1 described below. M is a predetermined margin. It should be noted that the second time threshold Tth2 calculated by the expression 1 is smaller than the first value T1.

Tth2=(df+M)/Vs (1)

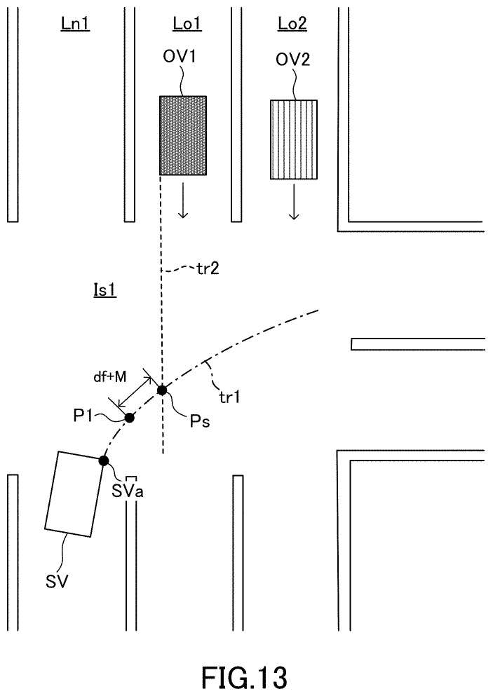

FIG. 13 is a view which corresponds to FIG. 7 overlapped with the first and second predicted routes tr1 and tr2 calculated on the two-dimensional map. A position remote from the crossing position Ps by df+M on the first predicted route tr1 will be referred to as “first position P1”. In case that the second time threshold Tth2 calculated by the expression 1 is used, the PCS control is started to be executed when the right corner portion SVa of the own vehicle SV reaches the first position P1. Thereby, the own vehicle SV stops at a position just before the right corner portion SVa reaches the second predicted route tr2. In other words, the own vehicle SV stops at a position remote from the crossing position Ps by the margin M. As described above, the CPU may set the second time threshold Tth2 such that the own vehicle SV stops at a position (P1) just before the own vehicle SV collides with the control target vehicle OV1. With the configuration described above, when the predetermined first behavior condition is satisfied, the vehicle control apparatus can delay a timing that the predetermined PCS execution condition becomes satisfied, to a timing that the own vehicle SV stops at the position just before the second predicted route tr2. Thus, the vehicle control apparatus of this embodiment can limit the execution of the PCS control in the unnecessary situation with ensuring a safety of the own vehicle SV.

### Modified Example 2

The predetermined first behavior condition is not limited to ones of the above-described examples. The CPU may be configured or programmed to determine that there is the predetermined behavior difference when there is a predetermined difference in motion vector defined by the moving direction and the moving speed between the control target vehicle OV1 and the surrounding vehicle OV2 or when there is a predetermined difference in the change amount of the motion vector per unit time between the control target vehicle OV1 and the surrounding vehicle OV2, i.e., there is a predetermined difference in the change amount of the moving direction per unit time and the change amount of the moving speed per unit time between the control target vehicle OV1 and the surrounding vehicle OV2.

For example, the condition C1 may be another condition as far as the condition C1 is a condition used to determine whether there is a difference between the moving direction Drl of the control target vehicle OV1 and the moving direction Dr2 of the surrounding vehicle OV2. For example, the PCS ECU 10 may be configured to calculate a lateral acceleration of the control target vehicle OV1 and a lateral acceleration of OV2, based on the object information. In this case, the condition C1 may be a condition described below.

Condition C1: the lateral acceleration of the control target vehicle OV1 is a value which corresponds to a right-turn direction, and the lateral acceleration of the surrounding vehicle OV2 is zero, i.e., the surrounding vehicle OV2 moves straight.

In another example, the PCS ECU 10 may be configured to calculate a turning angle or a yaw rate of the control target vehicle OV1 from a history of the moving direction Drl of the control target vehicle OV1 and calculate a turning angle or a yaw rate of the surrounding vehicle OV2 from a history of the moving direction Dr2 of the surrounding vehicle OV2. In this case, the condition C1 may be a condition described below.

Condition C1: A magnitude of a difference between the turning angle or the yaw rate of the control target vehicle OV1 and the turning angle or the yaw rate of the surrounding vehicle OV2 is greater than or equal to a predetermined threshold.

It should be noted that in the example shown in FIG. 7, the PCS ECU 10 may be configured to determine whether the surrounding vehicle OV2 moves straight, based on the object information. When the surrounding vehicle OV2 does not move straight such as when the surrounding vehicle OV2 turns left, the PCS ECU 10 cannot accurately determine whether the control target vehicle OV1 is turning right, based on the predetermined first behavior condition. Thus, when the surrounding vehicle OV2 turns left, the PCS ECU 10 may determine “No” at the step 1204 of the routine shown in FIG. 12 and set the second time threshold Tth2 to the first value T1.

### Modified Example 3

The surrounding vehicle condition is not limited to ones of the examples described above. The PCS ECU 10 recognizes positions of the lane markings which define the oncoming lanes, based on the lane information included in the vehicle surroundings information. The PCS ECU 10 may be configured to set the oncoming vehicles which move in a lane next to a lane in which the control target vehicle moves, as the surrounding vehicles.

### Modified Example 4

The predetermined PCS execution condition is not limited to ones of the example described above. For example, the predetermined PCS execution condition may be a condition which satisfied when the distance ds is shorter than or equal to a predetermined distance threshold. Also, with this configuration, the PCS ECU 10 may change the predetermined PCS execution condition to a condition which becomes satisfied at a later timing when the predetermined first behavior condition becomes satisfied, compared with when the predetermined first behavior condition is not satisfied. For example, the PCS ECU 10 may set the predetermined distance threshold to a smaller value when the predetermined first behavior condition is satisfied, compared with when the predetermined first behavior condition is not satisfied.

### Modified Example 5

The CPU may be configured or programmed to start to execute the routines shown in FIG. 11 and FIG. 12, based on information provided from a navigation system (not shown). For example, the CPU may be configured or programmed to start to execute the routines shown in FIG. 11 and FIG. 12 when the CPU determines that the own vehicle SV is approaching the intersection or the own vehicle SV moves in the right-turn-only lane, based on the information provided from the navigation system.

### Modified Example 6

In the embodiment described above, the examples of countries and regions which employ the left-hand traffic regulation. However, the configurations described above can be applied to countries and regions which employ a right-hand traffic regulation. In these countries and regions which employ the right-hand traffic regulation, the PCS ECU 10 executes the routines shown in FIG. 11 and FIG. 12 when the PCS ECU 10 determines that the own vehicle SV is turning left.

What is claimed is:

1. A vehicle control apparatus, comprising:
at least one sensor which acquires object information on objects in a surrounding area around an own vehicle, which surrounding area including a forward area ahead of the own vehicle; and
a control unit which is configured to:
select an oncoming vehicle which approaches the own vehicle and is likely to collide with the own vehicle, based on the object information when the own vehicle turns right or left;
set the selected oncoming vehicle as a control target vehicle; and
execute a collision avoidance control of avoiding a collision of the own vehicle with the control target vehicle when a predetermined execution condition that the own vehicle is likely to collide with the control target vehicle, is satisfied,
wherein the control unit is configured to:
select at least one oncoming vehicle which approaches the own vehicle and is around the control target vehicle;
set the selected at least one oncoming vehicle as a surrounding vehicle; and
change the predetermined execution condition to a condition which becomes satisfied at a later timing when a first behavior condition that there is a predetermined behavior difference between a behavior of the control target vehicle and a behavior of the surrounding vehicle, is satisfied, compared with when the first behavior condition is not satisfied.

2. The vehicle control apparatus as set forth in claim 1, wherein the control unit is configured to determine that there is the predetermined behavior difference when there is a predetermined motion vector difference in motion vector between the control target vehicle and the surrounding vehicle or when there is a predetermined change amount difference in change amount per unit time of the motion vector between the control target vehicle and the surrounding vehicle.

3. The vehicle control apparatus as set forth in claim 1, wherein the control unit is configured to determine that the first behavior condition is satisfied when at least one of (i) a first condition which relates to a difference in moving direction between the control target vehicle and the surrounding vehicle, (ii) a second condition which relates to a difference in acceleration between the control target vehicle and the surrounding vehicle, and (iii) a third condition which relates to a difference in speed in the moving direction between the control target vehicle and the surrounding vehicle, is satisfied.

4. The vehicle control apparatus as set forth in claim 3, wherein the control unit is configured to determine that the first condition is satisfied when a difference between (i) an angle defined by a reference axis and the moving direction of the control target vehicle and (ii) an angle defined by the reference axis and the moving direction of the surrounding vehicle, is greater than or equal to a predetermined angle difference threshold.

5. The vehicle control apparatus as set forth in claim 3, wherein the control unit is configured to determine that the second condition is satisfied when (i) the acceleration of the control target vehicle is smaller than zero, and (ii) the acceleration of the surrounding vehicle is greater than or equal to zero.

6. The vehicle control apparatus as set forth in claim 3, wherein the control unit is configured to determine that the third condition is satisfied when (i) the speed of the control target vehicle is lower than the speed of the surrounding vehicle, and (ii) the difference in speed between the surrounding vehicle and the control target vehicle, is greater than or equal to a predetermined speed difference threshold.

7. The vehicle control apparatus as set forth in claim 1, wherein:
the predetermined execution condition is a condition that time which the own vehicle will take to reach a route along which the control target vehicle predictively moves, is shorter than or equal to a time threshold; and
the control unit is configured to set the time threshold to a smaller value when the first behavior condition is satisfied, compared with when the first behavior condition is not satisfied.

8. The vehicle control apparatus as set forth in claim 7, wherein:
the collision avoidance control includes a braking force control of applying a braking force to wheels of the own vehicle; and
the control unit is configured to:
when the first behavior condition is satisfied, calculate a braking distance which the own vehicle moves until the own vehicle stops since the collision avoidance control is started to be executed; and
set the time threshold to a value which allows the own vehicle to stop at a position just before the route, based on the braking distance.

9. The vehicle control apparatus as set forth in claim 1, wherein:
the control unit is configured to:
when the control unit selects the oncoming vehicles around the control target vehicle as the surrounding vehicles, determine whether a second behavior condition that a behavior difference between the surrounding vehicles is small, is satisfied; and
when the second behavior condition is satisfied, determine whether the first behavior condition is satisfied.
